(19) United States
(12) Patent Application Publication
(10) Pub. No.: US 2004/0192432 A1
(43) Pub. Date: Sep. 30, 2004

(54) Method and apparatus for bounding play of a gaming device

(76) Inventors: Jay S. Walker, Ridgefield, CT (US); James A. Jorasch, Stamford, CT (US); Daniel E. Tedesco, Huntington, CT (US); John M. Packes JR., Hawthorne, NY (US)

Correspondence Address: WALKER DIGITAL, FIVE HIGH RIDGE PARK, STAMFORD, CT, 06905, US

(21) Appl. No.: 10/792,014

(22) Filed: Mar. 3, 2004

Related U.S. Application Data
(60) Provisional application No. 60/451,969, filed on Mar. 4, 2003.
(60) Provisional application No. 60/452,164, filed on Mar. 4, 2003.

(51) Int. Cl. A63F 13/00

(52) U.S. Cl. 463/20

(57) ABSTRACT

In accordance with one or more embodiments, a method for terminating play of a game session at a gaming device is provided. The method includes determining a game parameter, determining a terminating value associated with the parameter, determining whether the terminating value is reached, and terminating play of the game session.

The present Application:

(i) claims the benefit of U.S. Provisional Application No. 60/451,969, filed Mar. 4, 2003, entitled “METHOD AND APPARATUS FOR BOUNDING PLAY OF A GAMING DEVICE”; and also

(ii) claims the benefit of U.S. Provisional Application No. 60/452,164, filed Mar. 4,2003, entitled “METHOD AND APPARATUS FOR ASSOCIATING SYMBOLS WITH A STATE OF A GAMING DEVICE.”

The entirety of each of the above applications is incorporated by reference herein for all purposes.

### CROSS-REFERENCE TO RELATED APPLICATIONS

This application is related to the following commonly-owned and co-pending applications:

(i) U.S. patent application Ser. No. 10/XXXXXX [Attorney Docket No. 03-011], filed Feb. 23, 2004, entitled “METHOD AND APPARATUS FOR SETTING GAME PARAMETERS”; which claims the benefit of U.S. Provisional Patent Application No. 60/449,270, filed Feb. 21, 2003, entitled “METHOD AND APPARATUS FOR SETTING GAME PARAMETERS”;

(ii) U.S. patent application Ser. No. 10/001,089, filed Nov. 2, 2001, entitled “GAMING DEVICE FOR A FLAT RATE PLAY SESSION AND METHOD OF OPERATING SAME”; which:

(a) claims the benefit of U.S. Provisional Patent Application No. 60/282,792, filed Apr. 10, 2001, entitled “GAMING CONTRACTS”; and

(b) is a continuation-in-part of U.S. patent application Ser .No. 09/518,760,filed Mar. 3, 2000, entitled “GAMING DEVICE FOR A FLAT RATE PLAY SESSION AND METHOD OF OPERATING SAME,” issued on Nov. 20, 2001, as U.S. Pat. No. 6,319,127 B1; which is a continuation of U.S. patent application Ser. No. 08/880,838, filed Jun. 23, 1997, entitled “GAMING DEVICE FOR A FLAT RATE PLAY SESSION AND A METHOD OF OPERATING SAME,” issued on Jun. 20, 2000, as U.S. Pat. No. 6,077,163; and

(iii) U.S. patent application Ser. No. 10/778,576, filed Feb. 13, 2004, entitled “METHOD AND APPARATUS FOR ENHANCED PLAY OF A GAMING DEVICE”; which:

(a) is a continuation-in-part of U.S. patent application Ser. No. 10/772,837, filed Feb. 05, 2004, entitled “ELECTRONIC AMUSEMENT DEVICE AND METHOD FOR ENHANCED SLOT

MACHINE PLAY”;

(b) is a continuation-in-part of U.S. patent application Ser. No. 09/716,918, filed Nov. 20, 2000, entitled “ELECTRONIC AMUSEMENT DEVICE AND METHOD FOR ENHANCED SLOT MACHINE PLAY”; which is a continuation of U.S. patent application Ser. No. 09/164,473, filed Oct. 1, 1998, entitled “ELECTRONIC AMUSEMENT DEVICE AND METHOD FOR ENHANCED SLOT

MACHINE PLAY,” which issued as U.S. Pat. No. 6,203,430 B1 on Mar. 20, 2001; and

(c) claims the benefit of priority of U.S. Provisional Application Nos. 60/447,265 and 60/447,350, both filed on Feb. 13, 2003.

The entirety of each of the above applications is incorporated by reference herein for all purposes.

### FIELD OF THE INVENTION

The present invention relates to gaming and gaming devices.

### BACKGROUND

Gaming devices (e.g., reeled slot machines, video poker machines) generate more than $15 billion per year in revenue for casinos in the United States alone. This figure accounts for more than half of the gaming revenue for a typical United States casino. The situation is similar in other countries and regions in which gaming devices are popular, such as Australia and Europe. Accordingly, casino operators are interested in increasing the enjoyment of playing gaming devices in order to maintain or increase this level of revenue.

Since casino profits are directly proportional to the amount wagered by patrons, casinos are highly motivated to expand and retain share within their given market. Increased playing duration, average wager, and rates of play by players are all factors that contribute to the profitability of the slot floor of a casino.

One way in which casinos have sought to boost profitability associated with such factors is to make the machines as entertaining as possible. Many techniques are currently used to entertain players at a slot machine, such as attractive colors and graphics, sound effects associated with winning payouts, and jackpots or bonus rounds that offer players the chance to win a large amount of money for only a small wager. While such efforts have made modem slot machines more entertaining than the previous generation of machines, entertainment options open to consumers have been expanding as well. Casinos now compete not only with the casino across the street, but with alternative player entertainment options such as home theater systems, handheld video game devices, greatly expanded television and movie offerings, and the like.

Accordingly, a need exists for enhancing the entertainment value of gaming devices.

### BRIEF DESCRIPTION OF THE FIGURES

The accompanying drawings depict some exemplary embodiments of the present invention:

FIG. 1 is a diagram illustrating an example system according to some embodiments of the present invention;

FIG. 2 is a diagram illustrating an example alternative system according to some embodiments of the present invention;

FIG. 3 is a diagram illustrating an example gaming device according to some embodiments of the present invention;

FIG. 4 is a table illustrating an example data structure of a probability database for use in some embodiments of the present invention;

FIG. 5 is a table illustrating an example data structure of a payout database for use in some embodiments of the present invention;

FIG. 6 is a table illustrating an example data structure of a parameter value database for use in some embodiments of the present invention;

FIG. 7 is a flow chart illustrating an example process according to some embodiments of the present invention; and

FIG. 8 is a flow chart illustrating an example process according to some embodiments of the present invention.

### DETAILED DESCRIPTION

One or more embodiments of the present invention provide for terminating play of a game session based on a game parameter value. Some embodiments of the present invention allow for slot machine games in which a player plays a game session for an indefinite period of time or a variable number of handle pulls, based on the status of one or more game parameters. When the parameter value reaches a predetermined value, the game session is terminated.

Various embodiments of the present invention allow gaming devices to set or modify game parameters through the use of random events such as spinning slot machine reels. In some embodiments, game parameters may be established with various initial values. Such parameters include, for example, a number of fruit symbols “collected” by the player (e.g., the number of fruit symbols appearing on the payline of the game). Parameter values may be used to control almost any aspect of the gaming device play experience, ranging from the types of symbols seen on the reels to the rate at which “complementary” points are awarded.

Various embodiments of the present invention are described herein with reference to the accompanying drawings. The leftmost digit(s) of a reference numeral typically identifies the figure in which the reference numeral first appears.

In the following description, reference is made to the accompanying drawings that form a part hereof, and in which are shown, by way of illustration, specific embodiments in which the invention may be practiced. These embodiments are described in sufficient detail to enable those skilled in the art to practice the invention. It will be understood that other embodiments may be utilized and that structural, logical, software, and electrical changes may be made without departing from the scope of the present invention. The following description is, therefore, not to be taken in a limited sense, and the scope of the present invention is defined by the appended claims.

Throughout the description that follows and unless otherwise indicated, the following terms may include and/or encompass example meanings described herein. These terms and illustrative example meanings are provided to clarify the language selected to describe embodiments of the invention both in the specification and in the appended claims.

The term “basic game” may refer to play resulting from the spinning of standard physical or graphical slot reels, the dealing of physical or electronic cards, or other game outcomes. The outcome of a basic game might be cherry-cherry-bar; four hits on a seven-spot keno ticket; or the hand of Ks (king of spades), Qd (queen of diamonds), 4h (four of hearts), 2s (two of spades), 6s (six of spades) in video poker.

The term “bonus game” may refer to a secondary game separate from the basic game in which the player typically does not have to wager any additional coins and has the possibility of winning a relatively large number of coins.

The term “game play parameter” may refer to variables whose values govern aspects of play at the gaming device, exclusive of variables directly related to payout amounts, pay table selection, and payout probabilities. The value of a game play parameter may be determined, for example, by a random selection process, or may be selected by a player. Examples include the number of bar symbols that a player must collect, the number of cherry symbols collected by a player that are still remaining (e.g., in a game in which collected symbols may be lost or stolen), the number of handle pulls for which a bonus mode will remain active, the probability of a game character appearing on a given handle pull, a maximum number of hearts a player is allowed to be dealt in a poker game, and a maximum number of losing outcomes a player is allowed in a game session.

The term “game parameter” may refer to variables whose values govern play at the gaming device and may be determined, for example, by player selection or by a random selection process. Game parameters include game play parameters. Examples of game parameters include the payout for bar-bar-bar, the number of cherry symbols on the first reel, and the probability of a game character finding hidden treasure.

The term “game parameter value” may refer to a value (or set of values) associated with a game parameter, such as two hundred coins, twelve cherry symbols, or a 30% chance of finding treasure. Game parameter values include terminating values.

The term “terminating value” may refer to a value (or set of values) associated with a game parameter. If the game parameter attains a terminating value, play of a gaming device, game, game stage, or game session may be terminated. For example, one type of game may allow a player to keep making reel spins (e.g., without making per-spin wagers) until three or more “Poison” reel symbols have appeared. If a game play parameter is used to track the number of “Poison” reel symbols that have appeared on the payline, then the corresponding terminating value would be three.

The term “game parameter value symbol” may refer to a reel symbol that represents a game parameter value, such as a reel symbol displaying “200 coins” or “12 cherry symbols.” The symbol could also be found on other representations of random events such as spinners, which could be located on a secondary screen.

The term “controller” may refer to an electronic device (e.g., a personal computer) that communicates with one or more gaming devices. In a manner well known in the art, a controller may function as a computer server and may control the actions of gaming devices. A controller may also contain databases to record statistics such as coin-in, coin-out, jackpot information, theoretical wins, etc.

The term “game” may refer to a gambling event or activity with a beginning and an end. The activity may encompass and/or may be defined by a number of spins and/or period of time. Some games may have a beginning and/ or an end that is defined by a rule, condition, or is triggered. The beginning or end of a game may be indefinite, indeterminate, or variable. For example, a game may end when a game parameter has a particular value (e.g., when the player runs out of a particular collected game symbol), but exactly what time the game will end (e.g., when the parameter will have that particular value), and/or how many spins the game may encompass, may be indefinite. Of course, the end of some types of such games, even if indefinite or not yet determined, may be statistically predictable. The end of a game may be determined voluntarily (i.e., the player elects to stop play) and/or involuntarily (i.e., the player does not elect to stop play), such as by a gaming device or controller. Some types of games may have more than one state or stage (e.g., a first stage involving a first set of reel symbols and a second stage involving a second set of reel symbols; a basic game stage and a bonus game stage).

The terms “session,” “game session,” “gaming session,” and “play session” shall be synonymous and may refer to a series of plays, game stages, and/or games. Play during a gaming session may take place at one gaming device, at multiple gaming devices, and/or during a continuous period of time (e.g., in a casino location). As with a game, a gaming session may end voluntarily or involuntarily. The end of a game session, as discussed herein, may be defined, for example, by a number of handle pulls, by a period of time, by the accomplishment of one or more objectives, by the occurrence of a trigger or event, by the satisfaction of one or more conditions, and/or by a game parameter becoming associated with a particular value (e.g., a terminating value). A session might be purchased by means of purchasing a contract from a casino, wherein the contract specifies terms such as, for example, a price to be paid by the purchaser for the contract, a duration of play of a gaming device, and a threshold of credits above which the player may collect winnings from a gaming device. Apparatus and methods which, among other things, permit and enable various ways of providing contract play and game sessions such as prepaid sessions, flat rate play sessions, and which are appropriate for use in accordance with the present invention are disclosed in pending U.S. patent application Ser. No. 10/001,089, filed Nov. 2, 2001, entitled “GAME MACHINE FOR A FLAT RATE PLAY SESSION AND METHOD OF OPERATING SAME,” the entirety of which is incorporated herein by reference for all purposes.

The term “flat rate play session” may refer to a game session that is associated with a flat rate price. For example, a player may be able to play a desired number of handle pulls for a set price. In another example, a player's flat rate play session is not defined by time or by handle pulls, and will not end until some terminating condition has occurred (e.g., the player receives a flush in a video poker game).

The term “prepaid session” may refer to a period of time and/or a number of plays paid for in advance. The period of time or the number of plays may but need not be pre-established. For example, as discussed herein, some types of game sessions may not be defined by time or by a number of handle pulls. Once a session is prepaid, the player typically does not need to supply any additional funds until the session has completed. A prepaid session may allow the player to complete many games (including any number of basic and/or primary games) and/or handle pulls during the session.

The term “game character” may refer to a character, which may be a cartoon and/or digitally generated, which is involved in the game playing experience. The character may entertain the player, explain payouts, try to steal objects from the player, try to defend objects held by the player, and the like. The character could be a life-like animation of a television character, or even just the audio associated with a well-known character.

The term “gaming device” may refer to any electrical, mechanical, or electromechanical device that, in a manner well known in the art, accepts wagers, steps through a process to determine an outcome, and pays winnings based on the outcome. The outcome may be randomly generated, as with a slot machine; may be generated through a combination of randomness and player skill, as with video poker; or may be generated entirely through player skill. Gaming devices may include slot machines (both video and mechanical reels), video poker machines, video blackjack machines, video roulette machines, video keno machines, video bingo machines, pachinko machines, video lottery terminals, handheld gaming devices, and the like.

The term “handle pull” may refer to a single play at a gaming device whether or not a handle is involved in the play and whether or not a handle is even included in the gaming device. The meaning is intended to be flexible in that a single handle pull might constitute a single complete game, or a single wager. For example, a handle pull might represent a single spin of the reels or a series of spins which culminate in a final aggregate outcome. In a video poker embodiment, handle pulls may result in a first hand and a second hand, both in the same game.

The term “outcome” may refer to a result of a gaming event, such as cherry-cherry-cherry in a slot machine game, a push in blackjack, a flush in video poker, the completion of a puzzle, the attainment of a goal, etc. Different types of gaming devices may have widely varying types of outcomes. Several are described in detail herein and still others will be apparent to those of skill in the art based on the present disclosure.

The term “payout” may refer to a prize, reward, winnings, or bonus associated with a certain outcome.

The term “peripheral device” may refer to a device operatively connected to a gaming device that is configured to assist in the operation of game-related functions. In some embodiments peripheral devices may be located near players at a table game.

The term “player tracking card” may refer to a issued plastic or paper card (resembling a frequent shopper card) given to players by a casino as a way of identifying the player at a slot machine or table game. As is well known in the art, such cards typically have encoded thereon (in machine-readable and/or human readable form) a player identifier (e.g., a six digit number) which uniquely identifies the player (e.g., because the number is associated with a record in a database that includes corresponding player information). At a slot machine, the player inserts the card into a reader device and the player identifier is read from the card, most often magnetically. From the player identifier which the reader device reads, the corresponding player information may in turn be read from the database, typically via a network connection between the reader device and a deice hosting the database.

The term “primary game screen” may refer to a screen used to display game information such as a video representation of one or more spinning reels.

The term “secondary game screen” may refer to a screen used to display secondary game information such as the animation and graphics associated with a bonus round.

1. System

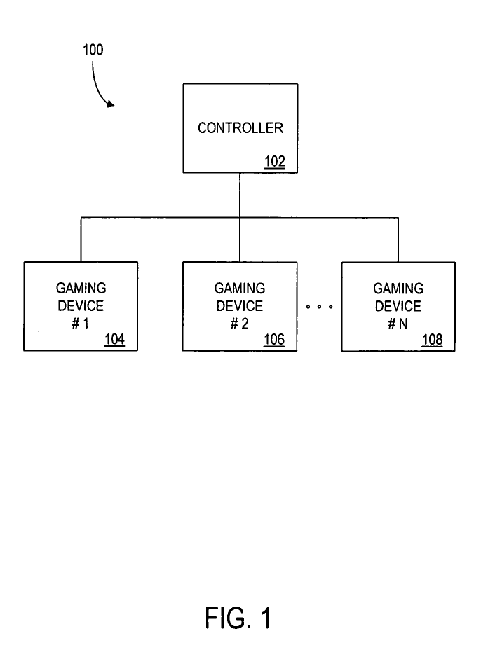

An example embodiment of the system 100 of the present invention is depicted in FIG. 1. The present invention can be configured to work as a system 100 in a network environment including a controller 102 (e.g., a slot server of a casino) that is in communication, via a communications network, with one or more gaming devices 104, 106, 108 (e.g., slot machines, video poker machines). The controller 102 may communicate with the gaming devices directly or indirectly, via a wired or wireless medium such as the Internet, LAN, WAN or Ethernet, Token Ring, or via any appropriate communications means or combination of communications means. Each of the gaming devices 104, 106, 108 may comprise computers, such as those based on the Intel® Pentium® processor, that are adapted to communicate with the controller 102. Any number and type of devices 104, 106, 108 may be in communication with the controller 102.

Communication between the devices 104, 106, 108 and the controller 102, and among the devices 104, 106, 108, may be direct or indirect, such as over the Internet through a Web site maintained by computer on a remote server or over an online data network including commercial online service providers, bulletin board systems and the like. In yet other embodiments, the devices 104, 106, 108 may communicate with one another and/or the controller 102 over RF, cable TV, satellite links and the like.

Some, but not all, possible communication networks that may comprise the network or be otherwise part of the system 100 include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

In some embodiments, a controller 102 may not be necessary and/or may not be preferred. For example, the present invention may, in one or more embodiments, be practiced on a stand-alone gaming device 104 and/or a gaming device 104 in communication only with one or more other gaming devices 106, 108. In such embodiments, any functions described as performed by the controller 102 or data described as stored on the controller 102 may instead be performed by or stored on one or more gaming devices 104, 106, 108.

In operation, the controller 102 and the gaming devices 104 may exchange information about the use of the gaming devices 104 by individual players, data about the players, messages, information about parameters, and the like. In embodiments with a third-party server, the controller 102 and/or the gaming devices 104 may exchange information about the use of the gaming devices 104 by individual players, data about the players, messages, parameter information, and the like, via the third-party server. The gaming devices 104 may, for example, provide information related to parameters and conditions to the controller 102 (and/or a third-party server). The gaming devices 104 may further provide gambling performance and player data to the controller 102 (and/or a third-party server). The controller 102 (and/or a third-party server) may provide information about parameters and/or historical information about the player to the gaming devices 104 in the casino location or to remote gaming devices.

It is worthwhile to note that the system 100 (and other systems described herein) may be arranged into a variety of configurations, with functionality residing in various locations. Various types of information may be transmitted between different devices. For example, the controller 102 may control most aspects of terminating a game session. It may determine a terminating value for a game parameter, track the value of a game parameter, and transmit a signal if it determines that a game session should be terminated. The signal may be received by a gaming device 104, which then terminates the game session.

In some embodiments as indicated above, the controller 102 may reside in a gaming device 104. For example, a gaming device 104 may control most aspects of terminating a game session. A gaming device 104 may not even have a network connection. In some embodiments, a terminating value may be determined by the controller 102, but a gaming device 104 may control when to terminate a game session. For example, a gaming device 104 may receive an indication of a terminating value from the controller 102, and the gaming device 104 then monitors play and game parameters during the game session to determine when the session should end (e.g., based on a generated outcome, based on the received terminating value).

Note that a wide variety of other configurations are possible, some of which are discussed herein. It should be understood that methods of the invention may be implemented by one or more gaming devices 104, one or more controllers 102, other devices, and/or any combination thereof.

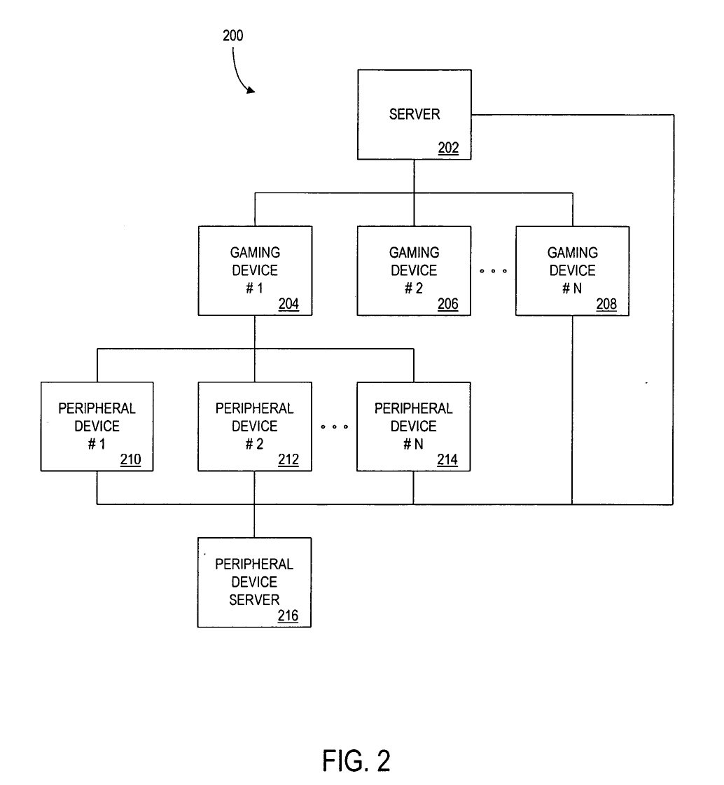

Turning to FIG. 2, an alternative system 200 according to some embodiments of the present invention includes a server 202 (e.g., a slot server of a casino) that is in communication, via a communications network, with one or more gaming devices 204, 206, 208 (e.g., slot machines, video poker machines). A difference between the aforementioned system 100 and this alternative system 200 is that in this system 200 at least one gaming device 204 is also in communication with one or more peripheral devices 210, 212, 214. A peripheral device 210, 212, 214 may, in turn, be in communication with a peripheral device server 216 and, in some embodiments, with the server 202. In some embodiments the peripheral device server 216 may be in communication with one or more gaming devices 204, 206, 208 and/or the server 202.

The server 202 may communicate with the devices 204, 206, 208 and peripherals 210, 212, 214 directly or indirectly, via a wired or wireless medium such as the Internet, LAN, WAN or Ethernet, Token Ring, or via any appropriate communications means or combination of communications means. For example, the server 202 may communicate directly with one of the gaming devices 204, 206, 208 (e.g., via a LAN) and indirectly (e.g., via a gaming device) with a peripheral device 210, 212, 214. In another example, the server 202 may communicate with one of the gaming devices 204 via a LAN and with another of the gaming devices 208 via the Internet (e.g., if the particular gaming device 208 comprises a personal computer in communication with an online casino).

Each of the devices 202, 204, 206, 208, 210, 212, 214, 216 of the system 200 may comprise computers, such as those based on the Intel® Pentium® processor, that are adapted to communicate with the computer. Further, each of the devices 202, 204, 206, 208, 210, 212, 214, 216 may comprise a gaming device such as a mechanical or electronic slot machine, a video poker machine, a video blackjack machine, a video keno machine, a pachinko machine, a video roulette machine, and/or a lottery terminal. Further yet, each of the devices 202, 204, 206, 208, 210, 212, 214, 216 may comprise an external or internal module associated with one or more of the gaming devices 204, 206, 208 that is capable of communicating with one or more of the gaming devices 204, 206, 208 and of directing the one or more gaming devices 204, 206, 208 to perform one or more functions. Any number of devices 204, 206, 208, 210, 212, 214, 216 may be in communication with the server 202. Any number and type of peripheral devices 210, 212, 214 may be in communication with a gaming device 204, peripheral device server 216 and the server 202.

Communication between the devices 204, 206, 208, 210, 212, 214 and the server 202, between each of the devices 204, 206, 208, 210, 212, 214, between the peripheral device server 216 and the devices 204, 206, 208, 210, 212, 214, and between the peripheral device server 216 and the server 202, may be direct or indirect, such as over the Internet through a Web site maintained by the server 202 on a remote server or over an online data network including commercial online service providers, bulletin board systems and the like. In yet other embodiments, any and all of the devices 204, 206, 208, 210, 212, 214, the server 202, and the peripheral device server 216 may communicate with one another over RF, cable TV, satellite links and the like.

Some, but not all, possible communication networks that may comprise the network or otherwise be part of the system include: a local area network (LAN), a wide area network (WAN), the Internet, a telephone line, a cable line, a radio channel, an optical communications line, a satellite communications link. Possible communications protocols that may be part of the system include: Ethernet (or IEEE 802.3), SAP, ATP, Bluetooth^{198 ,} and TCP/IP. Communication may be encrypted to ensure privacy and prevent fraud in any of a variety of ways well known in the art.

In some embodiments, the server 202 may not be necessary and/or may not be preferred. For example, the present invention may, in one or more embodiments, be practiced on a stand-alone gaming device 204, one or more gaming devices 204, 206, 208 in communication with one or more peripheral devices 210, 212, 214, one or more gaming devices 204, 206, 208 in communication with a peripheral device server 216, one or more peripheral devices 210, 212, 214 in communication with a peripheral device server 216, and/ or a gaming device 208 in communication only with one or more other gaming devices 204, 206. In such embodiments, any functions described as performed by the server 202 or data described as stored in a memory of the server 202 may instead be performed by or stored on one or more gaming devices 204, 206, 208, one or more peripheral devices 210, 212, 214, and/or peripheral device server 216.

Similarly, a peripheral device server 216 may not be desired and/or needed in some embodiments of the present invention. In embodiments that do not involve a peripheral device server 216, any or all of the functions described herein as being performed by a peripheral device server 216 may instead be performed by another server computer, the server 202, one or more gaming devices 204, 206, 208, one or more peripheral devices 210, 212, 214, or a combination thereof. Similarly, in embodiments that do not involve a peripheral device server 216 any data described herein as being stored in a memory of a peripheral device server 216 may instead be stored in a memory of another server computer, the server 202, one or more gaming devices 204, 206, 208, one or more peripheral devices 210, 212, 214, or a combination thereof.

Any or all of the gaming devices 204, 206, 208 may, respectively, include or be in communication with a peripheral device 210. A peripheral device 210 may be a device that receives information from (and/or transmits information to) one or more gaming devices 204, 206, 208. For example, a peripheral device 210 may be operable to receive information about games being played on a gaming device 204, such as the initiation of a game and/or a random number that has been generated for a game.

In one or more embodiments, one or more such peripheral devices 210, 212, 214 may be in communication with a peripheral device server 216. This allows the peripheral device server 216 to receive information regarding a plurality of games being played on a plurality of gaming devices 204, 206, 208. The peripheral device server 216, in turn, may be in communication with the server 202. It should be understood that any functions described herein as performed by a peripheral device 210 may also or instead be performed by the peripheral device server 216. Similarly, any data described herein as being stored on or accessed by a peripheral device 210 may also or instead be stored on or accessed by the peripheral device server 216.

A peripheral device 210 may be operable to access a database (e.g., of a peripheral device server 216) to provide benefits (e.g., cashless gaming receipts) based on, for example, an actual outcome of a game. A peripheral device 210 may be operable to access a parameter value database to terminate a game session, based on, for example, a terminating value of a game parameter.

The peripheral device server 216 may also monitor player gambling history over time by associating gambling behavior with player identifiers, such as player tracking card numbers. For example, information about the player obtained or accessed by a peripheral device server 216 may be analyzed, e.g., to identify those players that a particular gaming machine owner, operator, or manufacturer finds most desirable. Based upon desired objectives, the peripheral device server 216 may direct the appropriate peripheral device 210 to issue customized messages, offers, and games to specific players.

Information received by a peripheral device 210 from a gaming device 204 may include gambling data such as number of games initiated per unit of time, outcomes displayed for games initiated, payouts corresponding to outcomes displayed, a credit meter balance of the gaming device 204, and/or data associated with the player currently playing the gaming device 204.

The functions described herein as being performed by a peripheral device server 216 and/or a peripheral device 210 may, in one or more embodiments, be performed by the server 202 (in lieu of or in conjunction with being performed by a peripheral device server 216 and/or a peripheral device 210).

In some embodiments, a peripheral device 210 may be useful for implementing the embodiments of the present invention into the operation of a conventional gaming device. For example, in order to avoid or minimize the necessity of modifying or replacing a program already stored in a memory of a conventional gaming device, an external or internal module that comprises a peripheral device 210 may be inserted in or associated with a conventional gaming device to transform it into a gaming device 204 of the present invention.

Thus, for example, a peripheral device 210 may be utilized to monitor play of the gaming device 204 and to terminate a game session (or signal that a game session should be terminated). In such embodiments the gaming device 204 with which the peripheral device 210 is in communication may continue to operate conventionally, for example, by continuing to output an outcome for each handle pull. The peripheral device 210, however, may transmit a signal to prevent any further handle pulls until the player pays for another game session. The peripheral device 210 may also output messages to the player. The peripheral device 210 may also provide benefits to a player (e.g., coins, tokens, electronic credits, paper receipts exchangeable for cash, services, and/or merchandise).

Accordingly, a peripheral device 210 may include (i) a communications port (e.g., for communicating with one or more gaming devices, peripheral device server, another peripheral device, and/or computer), (ii) a display (e.g., for displaying messages and/or outcomes and payouts), (iii) another output means (e.g., a speaker, light, or motion device to communicate with a player), and/or (iv) a benefit providing means (e.g., a printer and paper dispensing means, a ticket receiving and/or dispensing device, a credit meter, and/or a hopper and hopper controller).

In some embodiments, a peripheral device 210 may not output outcomes and/or messages to a player but may instead direct the processor 300 of a gaming device 104 to perform such functions. For example, a program stored in a memory of peripheral device 210 may cause a processor 300 of a gaming device 104 to perform certain functions. For example, a program stored in a memory of peripheral device 210 may cause a processor 300 of a gaming device 104 to output an outcome, determine an outcome, output a message, terminate a game session, access a database, provide a benefit, refrain from providing a benefit (e.g., by not sending a signal to a hopper controller of the gaming device when it otherwise normally would), and/or communicate with another device.

Examples of peripheral devices 210, 212, 214 include, without limitation, (1) electronic apparatuses “retrofitted” to conventional gaming devices so that inventive processes disclosed herein may be realized through game play at the gaming device 104, (2) Personal Digital Assistants such as those manufactured by Palm, Inc., (3) lap top computers, (4) cellular telephones, (5) pagers, or (6) any combination thereof.

2. Devices

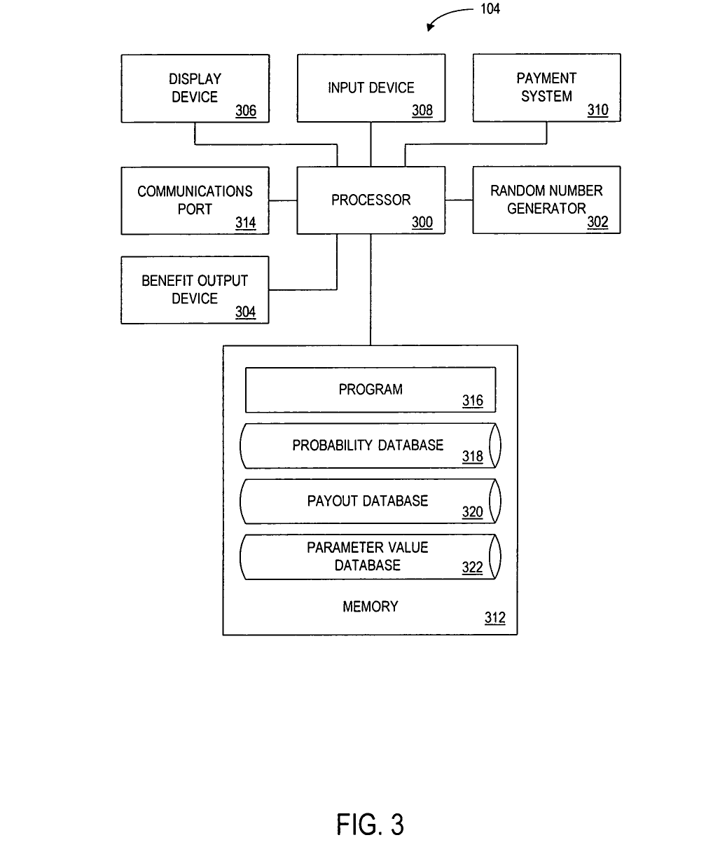

Turning to FIG. 3, a gaming device 104, 204 may be implemented as a system controller, a dedicated hardware circuit, an appropriately programmed general-purpose computer, or any other equivalent electronic, mechanical or electro-mechanical device. As indicated above, the gaming device 104 may comprise, for example, a slot machine, a video poker machine, a video blackjack machine, a video keno machine, a video lottery machine, a pachinko machine or a table-top game. In various embodiments, a gaming device 104 may comprise, for example, a personal computer (e.g., which communicates with an online casino Web site), a telephone (e.g., to communicate with an automated sports book that provides gaming services), or a portable handheld gaming device (e.g., a personal digital assistant or Nintendo GameBoy®). The gaming device 104 may comprise any or all of the gaming devices of the aforementioned systems. In some embodiments, a user device such as a PDA or cell phone may be used in place of, or in addition to, some or all of the gaming device components. Further, a gaming device 104 may comprise a personal computer or other device operable to communicate with an online casino and facilitate game play at the online casino. In one or more embodiments, the gaming device 104 may comprise a computing device operable to execute software that simulates play of a reeled slot machine game, video poker game, video blackjack game, video keno game, video roulette game, or lottery game.

In some embodiments, a gaming device 104 may comprise a processor 300, such as one or more Intel® Pentium® processors. The processor 300 is operable to communicate with a random number generator 302, which may be a component of the gaming device 104. The random number generator 302, in accordance with some embodiments of the present invention, may generate data representing random or pseudo-random values (referred to as “random numbers” herein). The random number generator 302 may generate a random number every predetermined unit of time (e.g., every thousandth of a second) or in response to an initiation of a game on the gaming device 104. In some embodiments, the generated random numbers may be used as they are generated (e.g., the random number generated at substantially the time of game initiation is used for that game) and/or stored for future use. A random number generated by the random number generator 302 may be used by the processor 300 to determine, for example, at least one of an outcome and payout. A random number generator 302, as used herein, may be embodied as a processor separate from but working in cooperation with the processor 300. Alternatively, the random number generator 302 may be embodied as an algorithm, program component, or software stored in the memory of the gaming device 104 and used to generate a random number.

Note that, although the generation or obtainment of a random number is described herein as involving a random number generator 302 of a gaming device 104, other methods of determining a random number may be employed. For example, a gaming device owner or operator may obtain sets of random numbers that have been generated by another entity. HotBits™, for example, is a service that provides random numbers that have been generated by timing successive pairs of radioactive decays detected by a Geiger-Muller tube interfaced to a computer. A blower mechanism that uses physical balls with numbers thereon may be used to determine a random number by randomly selecting one of the balls and determining the number thereof.

The processor 300 may also be operable to communicate with a benefit output device 304, which may be a component of gaming device 104. The benefit output device 304 may comprise one or more devices for outputting a benefit to a player of the gaming device. For example, in some embodiments the gaming device 104 may provide coins and/or tokens as a benefit. In such embodiments, the benefit output device 304 may comprise a hopper and hopper controller, for dispensing coins and/or tokens into a coin tray of the gaming device. In another example, the gaming device 104 may provide a receipt or other document on which there is printed an indication of a benefit (e.g., a cashless gaming receipt that has printed thereon a monetary value, which is redeemable for cash in the amount of the monetary value). In such embodiments, the benefit output device 304 may comprise a printing and document dispensing mechanism. In yet another example, the gaming device 104 may provide electronic credits as a benefit (which, e.g., may be subsequently converted to coins and/or tokens and dispensed from a hopper into a coin tray). In such embodiments, the benefit output device 304 may comprise a credit meter balance and/or a processor that manages the number of electronic credits that is indicated on a display of a credit meter balance. In yet another example, the gaming device 104 may credit a monetary amount to a financial account associated with a player as a benefit provided to a player. The financial account may be, for example, a credit card account, a debit account, a charge account, a checking account, or a casino account. In such embodiments, the benefit output device 304 may comprise a device for communicating with a server on which the financial account is maintained.

Note that, in one or more embodiments, the gaming device 104 may include more than one benefit output device 304. For example, the gaming device 104 may include both a hopper and hopper controller combination and a credit meter balance. Such a gaming device 104 may be operable to provide more than one type of benefit to a player of the gaming device 104. A single benefit output device 304 may be operable to output more than one type of benefit. For example, a benefit output device 304 may be operable to increase the balance of credits in a credit meter and communicate with a remote device in order to increase the balance of a financial account associated with a player.

The processor 300 is also operable to communicate with a display device 306, which may be a component of gaming device 104. The display device 306 may comprise, for example, one or more display screens or areas for outputting information related to game play on the gaming device, such as a cathode ray tube (CRT) monitor, liquid crystal display (LCD) screen, or light emitting diode (LED) screen. In one or more embodiments, a gaming device 104 may comprise more than one display device 306. For example, a gaming device may comprise an LCD display for displaying animated game features and a display area that displays rotating mechanical reels.

The processor 300 may also be in communication with one or more other devices (not pictured) besides the display device 306, for outputting information (e.g., to a player or another device). Such other one or more output devices may also be components of a gaming device 104. Such other one or more output devices may comprise, for example, an audio speaker (e.g., for outputting an outcome or information related thereto, in addition to or in lieu of such information being output via a display device), an infra-red transmitter, a radio transmitter, an electric motor, a printer (e.g., such as for printing cashless gaming vouchers), a coupon or product dispenser, an infra-red port (e.g., for communicating with a second gaming device or a portable device of a player), a Braille computer monitor, and a coin or bill dispenser. For gaming devices 104, common output devices include a cathode ray tube (CRT) monitor on a video poker machine, a bell on a gaming device (e.g., rings when a player wins), an LED display of a player's credit balance on a gaming device, an LCD display of a personal digital assistant (PDA) for displaying keno numbers.

As indicated above, the display device 306 may comprise, for example, one or more display areas. For example, one of the display areas may display outcomes of games played on the gaming device 104 (e.g., electronic reels of a gaming device). Another of the display areas may display rules for playing a game of the gaming device 104. Yet another of the display areas may display the benefits obtainable by playing a game of the gaming device 104 (e.g., in the form of a payout table). In one or more embodiments, the gaming device 104 may include more than one display device 306, one or more other output devices, or a combination thereof (e.g., two display devices 306 and two audio speakers).

The processor may also be in communication with an input device 308, which is a device that is capable of receiving an input (e.g., from a player or another device) and which may be a component of gaming device 104. An input device 308 may communicate with or be part of another device (e.g., a server 202, a gaming device 104, etc.). Some examples of input devices 308 include: a bar-code scanner, a magnetic stripe reader, a computer keyboard or keypad, a button, a handle, a keypad, a touch-screen, a microphone, an infrared sensor, a device for receiving a ticket or voucher, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port (e.g., for receiving communications from a second gaming device or from a another device such as a smart card or PDA of a player), and a weight scale. For gaming devices 104, common input devices 308 may include a button or touch screen on a video poker machine, a lever or handle connected to the gaming device, a magnetic stripe reader to read a player tracking card inserted into a gaming device, a touch screen for input of player selections during game play, and a coin and bill acceptor.

The processor 300 may also be in communication with a payment system 310, which may be a component of the gaming device. The payment system 310 is a device capable of accepting payment from a player (e.g., a bet or initiation of a balance) and/or providing payment to a player (e.g., a payout). Payment is not limited to money, but may also include other types of consideration, including products, services, and alternate currencies. Exemplary methods of accepting payment by the payment system 310 include (i) receiving hard currency (i.e., coins or bills), and accordingly the payment system 310 may comprise a coin or bill acceptor; (ii) receiving an alternate currency (e.g., a paper cashless gaming voucher, a coupon, a non-negotiable token), and accordingly the payment system may comprise a bar code reader or other sensing means; (iii) receiving a payment identifier (e.g., a credit card number, a debit card number, a player tracking card number) and debiting the account identified by the payment identifier; and (iv) determining that a player has performed a value-added activity (e.g., participating in surveys, monitoring remote images for security purposes, referring friends to the casino).

The processor 300 is in communication with a memory 312 and a communications port 314 (e.g., for communicating with one or more other devices). The memory 312 may comprise an appropriate combination of magnetic, optical and/or semiconductor memory, and may include, for example, Random Access Memory (RAM), Read-Only Memory (ROM), a compact disc and/or a hard disk. The memory 312 may comprise or include any type of computer-readable medium. The processor 300 and the memory 312 may each be, for example: (i) located entirely within a single computer or other device; or (ii) connected to each other by a remote communication medium, such as a serial port cable, telephone line or radio frequency transceiver. In some embodiments, the gaming device 104 may comprise one or more devices that are connected to a remote server computer for maintaining databases.

The memory 312 stores a program 316 for controlling the processor 300. The processor 300 performs instructions of the program 316, and thereby operates in accordance with the present invention, and particularly in accordance with the methods described in detail herein. The program 316 may be stored in a compressed, uncompiled and/or encrypted format. The program 316 furthermore includes program elements that may be necessary, such as an operating system, a database management system and “device drivers” for allowing the processor 300 to interface with computer peripheral devices 302, 304, 306, 308, 310, 312, 314. Appropriate program elements are known to those skilled in the art, and need not be described in detail herein.

The terms “computer-readable medium” or “computer readable media” as used herein may refer to any media or medium that may participate in providing instructions to the processor 300 of the gaming device 104 (or any other processor of a device described herein) for execution. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Transmission media include coaxial cables, copper wire and fiber optics, including the wires that comprise a system bus coupled to the processor. Transmission media may carry acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying one or more sequences of one or more instructions to processor 300 (or any other processor of a device described herein) for execution. For example, the instructions may initially be borne on a magnetic disk of a remote computer. The remote computer can load the instructions into its dynamic memory and send the instructions over a telephone line using a modem. A modem local to a gaming device 104 (or, e.g., a controller 102) can receive the data on the telephone line and use an infrared transmitter to convert the data to an infrared signal. An infrared detector can receive the data carried in the infrared signal and place the data on a system bus for the processor. The system bus carries the data to main memory, from which the processor retrieves and executes the instructions. The instructions received by main memory may optionally be stored in memory either before or after execution by the processor.

In addition, instructions may be received via a communication port 314 as electrical, electromagnetic or optical signals, which are exemplary forms of carrier waves that carry data streams representing various types of information. Thus, the gaming device 104 may obtain instructions in the form of a carrier wave.

According to some embodiments of the present invention, the instructions of the program 316 may be read into a main memory from another computer-readable medium, such from a ROM. Execution of sequences of the instructions in the program 316 causes processor 300 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software. As discussed with respect to aforementioned systems 100, 200, execution of sequences of the instructions in a program 316 of a peripheral device 2 10 in communication with the gaming device 104 may also cause the processor 300 to perform some of the process steps described herein.

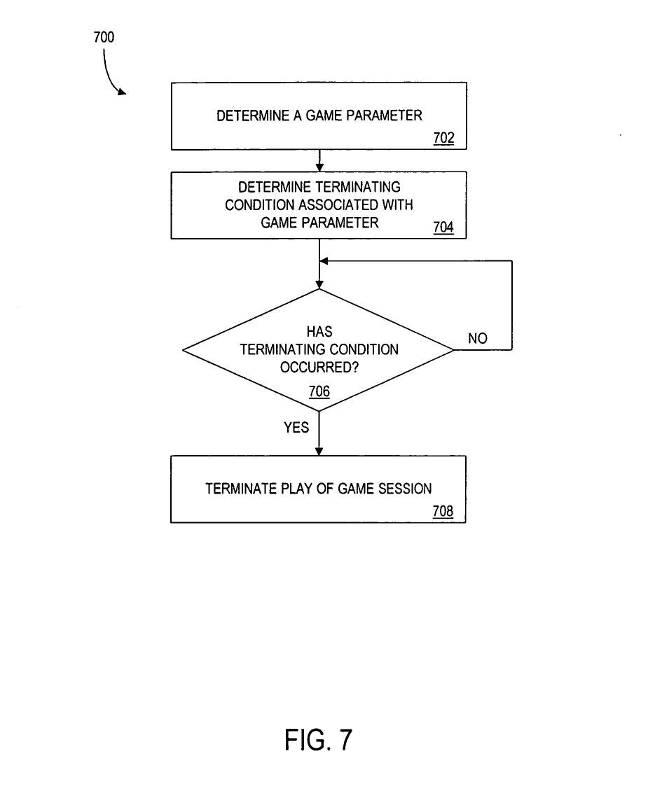

The program 316 may be operative to execute a number of invention-specific, objects, modules and/or subroutines which may include (but are not limited to) one or more routines to identify a player at the gaming device 104; one or more routines to receive information about a user; one or more routines to initiate game sessions; one or more routines to terminate game sessions; one or more routines to determine game parameters; one or more routines to determining terminating and/or initial values of game parameters; one or more routines to adjust the value of game parameters (e.g., based on game events); one or more routines to receive parameter information from a controller 102; one or more routines to receive signals from a controller 102 to adjust parameters; one or more routines to receive signals from a controller 102 to terminate a game session; one or more routines for determining a price for a prepaid or flat rate play session; one or more routines to store player performance information; one or more routines to store player preference information; one or more routines to facilitate and control communications between the gaming device 104 and/or third-party servers; one or more routines to restore the gaming device 104 to using its default parameter values; and/or one or more routines to control databases or software objects that track information regarding users, casinos, merchants supplying prizes, other third-parties, gambling results, other gaming devices, and awarding prizes. Examples of some of these routines and their operation are described below in conjunction with the flowchart depicted in FIG. 7.

The memory 312 may also store one or more databases, including a probability database 318, a payout database 320, and a parameter value database 322. The program 316 may include instructions for retrieving, manipulating, and storing data in the databases as may be useful in performing various methods of the invention, as will be further described below. Examples of some or all of the data stored in each database 318, 320, 322 is described herein. The described entries of the databases 318, 320, 322 represent exemplary information only; those skilled in the art will understand that the number and content of the entries can be different from those illustrated herein. Further, despite any description of the databases 318, 320, 322 as tables, an object-based model could be used to store and manipulate the data types of the present invention and likewise, object methods or behaviors can be used to implement the processes of the present invention.

Note that, although these databases 318, 320, 322 may be described as being stored in a gaming device 104, in other embodiments of the present invention some or all of these databases 318, 320, 322 may be partially or wholly stored in another device, such as one or more of the peripheral devices 210, 212, 214, the peripheral device server 216 and/or the server controller 102, 202. Further, some or all of the data described as being stored in the databases 318, 320, 322 may be partially or wholly stored (in addition to or in lieu of being stored in the memory 312 of the gaming device 104) in a memory of one or more other devices, such as one or more of the peripheral devices 210, 212, 214, the peripheral device server 216 and/or the server controller 102, 202.

As discussed herein, in at least one embodiment the gaming device 104 may be configured as a slot machine enabled to operate in conjunction with one or more processes the present invention. A more specific description of an exemplary slot machine suitable for use with at least one embodiment of the present invention follows. Of course, where appropriate, the slot machine may include fewer, different and/or additional components besides those discussed in this section. Also, it will be readily understood that some or all of the components and features described with respect to the exemplary slot machine may be used with one or more other types of gaming devices.

Generally, a slot machine comprises a three-reel or five-reel slot machine. The slot machine comprises a display area in which an outcome for a game of the slot machine is displayed to the player. The display area may, for example, be a video display that displays graphical representations of reels. In another example, the display area comprises glass, behind which mechanical reels are located. Within the display area, typically, is at least one payline. In some types of slot machine games, the player may choose to play using one or more available paylines. In accordance with one or more embodiments of the present invention, an outcome of a game comprises a set of symbols displayed along a payline of a reeled slot machine.

The slot machine may further comprise a handle. A player may initiate the movement of the reels in the display area by pulling on the handle. Alternatively, a player may initiate the movement of the reels in the display area by actuating a start button. Either or both of the handle and start button are exemplary embodiments of the input device 308, described herein. However it may be initiated, single play at a slot machine or other type of gaming device may be referred to herein as a “handle pull,” whether or not a handle is involved in the play, and whether or not a handle is even included in the gaming device. In some embodiments a handle pull or single play may describe a single complete game and/or a single wager. For example, a handle pull might represent a single spin of the reels and/or a series of reel spins (e.g., which may culminate in a final aggregate outcome). In a video poker embodiment, a handle pull may be associated with the result of a first hand and a second hand, both in the same game.

Where appropriate, the slot machine may also include an alternate, secondary game screen, for outputting information to a player. The secondary game screen may be utilized, for example, to inform a player of game information, provide an offer, output a message, indicate that a game session has been initiated, indicate the terminating value of a game parameter, indicating an offer to change a game parameter value, or indicate that a game session has been terminated.

The exemplary slot machine may also include a payment system comprised of a bill acceptor, a credit card reader, and a coin acceptor. A player may utilize the payment system to provide a wager for playing a game or game session. This payment system is an exemplary embodiment of the payment system 310, described herein.

The slot machine may further comprise a credit meter balance, which is an exemplary embodiment of a benefit output device 304 described herein. The credit meter balance reflects the amount of electronic credits currently available to a player. The electronic credits may be used by a player, for example, as wagers for games played on the gaming device. The electronic credits may also be “cashed out” as coins, bills, tokens, a cashless gaming receipt, and/or credits to another financial account associated with the player, as will be readily understood by those skilled in the art.

Finally, the slot machine may comprise a coin tray. As discussed herein, payment to the player may be rendered by dispensing coins into the coin tray. Such coins may be dispensed based on, for example, a player's indication that the player would like to cash out his credit meter balance and/or a payout obtained by a player as a result of playing a game on the slot machine. The coin tray is an exemplary embodiment of the benefit output device 304, described herein.

3. Databases

Although databases 318, 320, 322 are depicted as residing at the gaming device 104 in the example embodiment of FIG. 3, it will be understood that one or more of these databases could just as easily be implemented on one or more other devices.

Further, the individual database files could be stored on any number of different devices (e.g., located on different storage devices in different geographic locations, such as on a server 202 or a gaming device 104). For example, a gaming device may store a redundant copy of a controller's databases to protect against data loss or for any number of other reasons, and vice versa.

In embodiments in which, for example, the controller 102 serves/ controls multiple casinos operated by different entities, a casino may wish to have a local copy of the portions of the databases that include entries related to that casino and may wish to exclude other casinos'access to that casino's information. Thus, some embodiments of a gaming device 104 may include local copies of some portions of one or more of the databases stored at a controller. Such a redundant configuration may provide enhanced system performance by reducing network communications. A distributed configuration may provide enhanced system security by allowing different casinos to store and maintain their own databases. A gaming device program (e.g., program 316) may include one or more routines to respond to requests from other gaming devices for player data, message data, game data, and game parameter data. In some embodiments, local versions of the databases are not stored on the gaming devices 104 at all and instead, the game device program accesses casino server databases which are stored and maintained exclusively on the controller 102. Likewise, in some embodiments, the databases may only exist on a third-party server and thus, both the controller 102 and the gaming devices 104 may access a third-party server for the data.

As will be understood by those skilled in the art, the schematic illustrations and accompanying descriptions of the sample databases presented herein are exemplary arrangements for stored representations of information. Other database arrangements may be used which would still be in keeping with the spirit and scope of the present invention. Any number of arrangements may be employed besides those suggested by the accompany figures. For example, even though a particular number of separate databases are illustrated, various embodiments of the invention could be practiced effectively using any number of functionally equivalent databases. In other words, the present invention could be implemented using any number of different database files or data structures, as opposed to the number depicted. Similarly, the illustrated entries of the databases represent exemplary information only; those skilled in the art will understand that the number and content of the entries can be different from those illustrated herein. Further, despite the depiction of the databases as tables, an object-based model could be used to store and manipulate the data types of the present invention and likewise, object methods or behaviors can be used to implement the processes of the present invention. These processes are described below in detail with respect to FIG. 7.

3.1. Probability Database

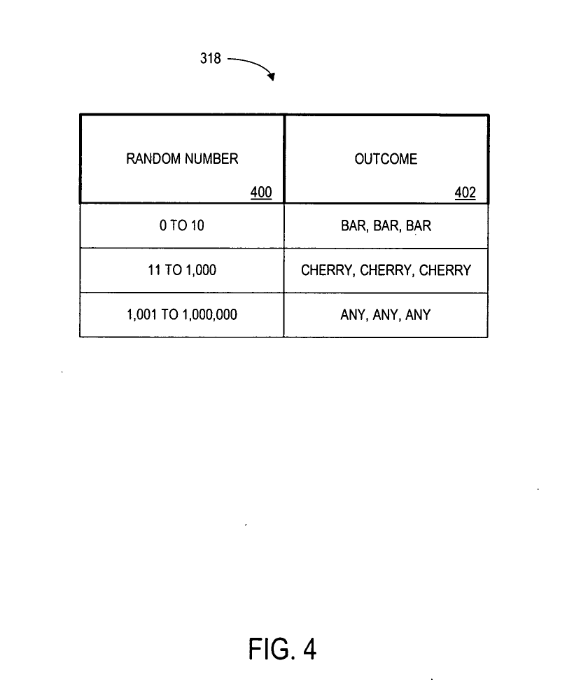

FIG. 4 depicts a tabular representation of an example of a probability database 318 according to some embodiments of the present invention. Where appropriate, a probability database 318 may be utilized in the performance of the inventive processes described herein. A probability database 318 may be stored in the memory 312 in tabular form, or any other appropriate database form, as is well known in the art. The data stored therein may include a number of exemplary records or entries, each defining a random number. Those skilled in the art will understand that the probability database 318 may include any number of entries. The tabular representation also defines, for each of the entries or records, fields that specify: (i) a random number 400 or range of random numbers that may be generated by the random number generator 302; and (ii) an outcome 402, that indicates the one or more indicia comprising the outcome that corresponds to the random number of a particular record.

A gaming device 104 may utilize a probability database 318 to determine, for example, what outcome corresponds to a random number generated by a random number generator 302 and to display the determined outcome. The outcomes may comprise, for example, the three symbols to be displayed along the payline of a three-reel slot machine. According to some embodiments of the present invention, an outcome may be used to determine whether a terminating value for a game session has been reached.

3.2. Payout Database

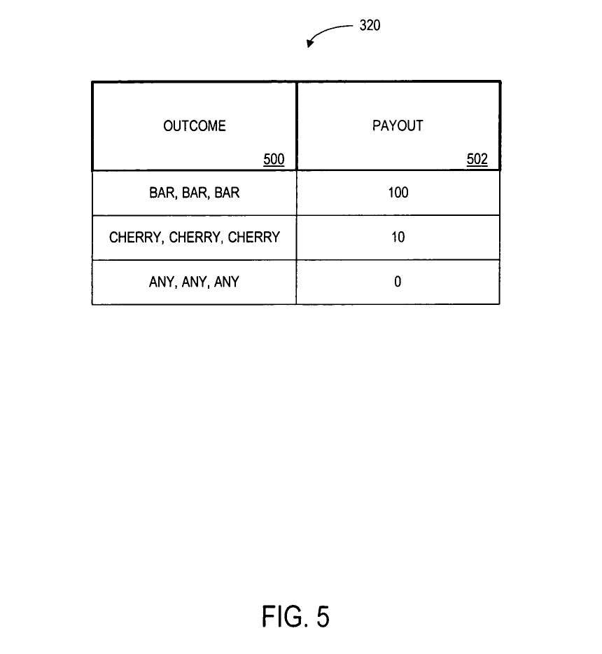

FIG. 5 depicts a tabular representation of an example of a probability database 320 according to some embodiments of the present invention. Where appropriate, a payout database 320 may be utilized in the performance of the inventive processes described herein. A payout database 320 may be stored in the memory 312 in tabular form, or any other appropriate database form, as is well known in the art. The data stored therein includes a number of example records or entries, each defining an outcome that may be obtained on a gaming device 104 that corresponds to a payout. Those skilled in the art will understand that the payout database 320 may include any number of entries. The tabular representation also defines fields for each of the entries or records. The fields specify: (i) an outcome 500, which indicates the one or more indicia comprising a given outcome; and (ii) a payout 502 that corresponds to each respective outcome. The outcomes may be those obtained, for example, on a three reel slot machine.

A gaming device 104 may utilize the payout database 320 to determine whether a payout 502 should be output to a player as a result of an outcome 500 obtained for a game. For example, after determining the outcome 500 to output on the gaming device, the gaming device may access the payout database 320 to determine whether the outcome 500 for output is one of the outcomes stored as corresponding to a payout 502, e.g., “BAR, BAR, BAR” or “CHERRY, CHERRY, CHERRY” in FIG. 5. If it is, the gaming device 104 may provide the corresponding payout 502 to the player.

Of course, many other arrangements of the probability database 318 and the payout database 320 are possible. For example, Winning at Slot Machines, by Jim Regan (Carol Publishing Group Edition, 1997), illustrates examples of payout and probability tables and how they may be derived. The entirety of this book is incorporated by reference herein for all purposes.

3.3. Parameter Value Database

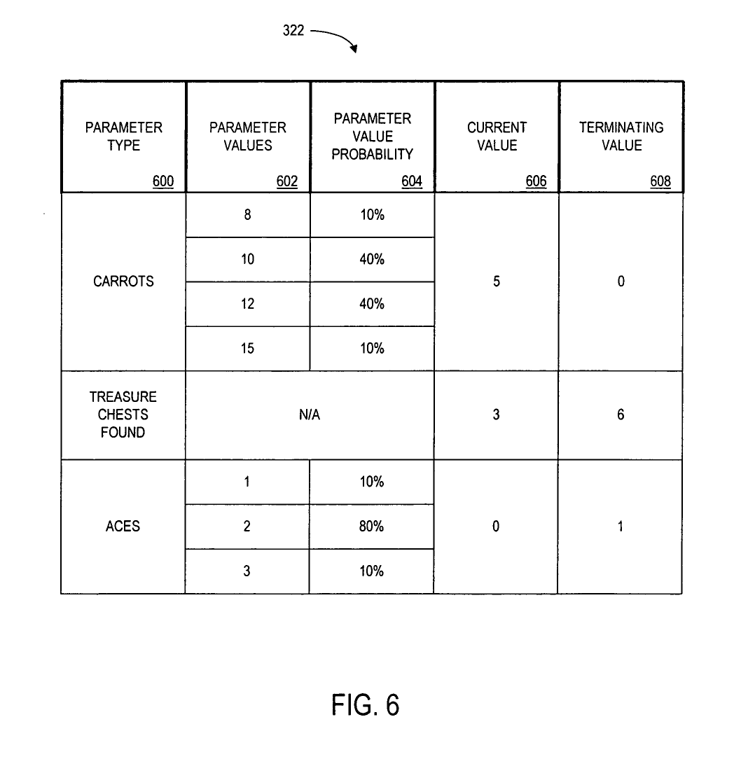

FIG. 6 depicts a tabular representation of an example of a parameter value database 322 according to some embodiments of the present invention. Where appropriate, a parameter value database 322 may be utilized in the performance of the inventive processes described herein. A parameter value database 322 may be stored in the memory 312 in tabular form, or any other appropriate database form, as is well known in the art. The data stored therein includes a number of example records or entries, each defining the current parameter value associated with a given parameter, as well as possible parameter values and/or the respective probabilities associated with the possible parameter values. Those skilled in the art will understand that the parameter value database 322 may include any number of entries. The tabular representation also defines fields for each of the entries or records. The fields specify: (i) a type of parameter 600; (ii) parameter values 602 that may be associated with the parameter; (iii) probabilities 604 associated with the possible parameter values; (iv) a current value 606 associated with the corresponding parameter; and (v) a terminating value 608 associated with the corresponding parameter.

According to some embodiments, parameter values 602 may correspond to possible initial values of the parameter 600. Such values may be used, for example, in determining the initial value of the parameter (e.g., based on the associated probabilities 604). For example, the parameter values 602 for the “carrot” parameter type 600 may be possible initial values for how many carrot symbols a player of the exemplary Garden Game (described further below) begins play with.

In other embodiments, parameter values 602 may correspond to possible terminating values of the parameter 600. Such values may be used, for example, in determining the terminating value(s) of the parameter (e.g., based on the associated probabilities 604). For example, the parameter values 602 for the “aces” parameter type 600 may be possible terminating values for a video poker session that ends once the player has been dealt a predetermined number of Aces (e.g., in one hand, or in total for a plurality of hands dealt).

A gaming device 104 may utilize the parameter value database 322, for example, to manage, track, and store parameter values during a gaming session. In accordance with some embodiments, a gaming device 104 may utilize the parameter value database 322 to determine whether to terminate a game session based on the terminating value 608 associated with a game parameter (and/or based on a current value 606 of a game parameter).

4. Processes

The exemplary system discussed above, including the hardware components, software components, and the databases, are useful to perform various methods of the invention. However, it should be understood that not all of the above-described components and databases are necessary to perform any of the methods of the present invention. In fact, in some embodiments, none of the above-described system is required to practice the methods of the present invention. The system described above is merely an example of a system that would be useful in practicing some methods of the invention.

Referring to FIG. 7, a flow chart 700 is depicted that represents some embodiments of the present invention. Although the method 700 is discussed as being performed by a slot machine, it will be understood in light of the present disclosure that the method may be performed by a controller 102, a gaming device 104, a peripheral device 210, a peripheral device server 216, and/or a casino. It must be understood that the particular arrangement of elements in the flow chart 700 of FIG. 7, as well as the number and order of example steps of other various methods discussed herein, is not meant to imply a fixed order, sequence, quantity, and/or timing to the steps. Embodiments of the present invention can be practiced in any order, sequence, and/or timing that is practicable. Likewise, the labels used to reference the individual steps of the methods are not meant to imply a fixed order, sequence, quantity, and/or timing to the steps.

In general terms and still referring to FIG. 7, method steps of some embodiments of the present invention may be summarized as follows. In step 702, one or more game parameters are determined. In step 704, terminating conditions associated with these game parameters are determined. In step 706, the system determines whether a terminating condition has occurred. If so, play of the game session is terminated in step 708. As indicated above, in some embodiments these steps may be performed in a different order, and more, fewer, and/or alternative steps may be used as well.

In the discussion that follows, each of these exemplary steps will be discussed in greater detail. Note that not all of these steps are required to perform the methods of the present invention and that additional and/or alternative steps are also discussed below. Also note that the above general steps represent features of only some of the embodiments of the present invention. Such steps may be combined and/or subdivided in any number of different ways so that methods of the present invention include more or fewer actual steps. For example, in some embodiments additional steps may be added to update and maintain the databases described above. As indicated, however, it is not necessary to use the above-described databases in all embodiments of the invention. In some embodiments, a described step may be performed by or with respect to any number of devices or entities. For example, a step may be subdivided into sub-steps, some of which are performed by one device, and some of which are performed by or otherwise involve a different device. In other words, the methods of the present invention may contain any number of steps performed by any number of entities that are practicable to implement the various different inventive processes described herein.

In step 702, one or more game parameters are determined. In some embodiments, the casino or gaming device 104 determines one or more game parameters. Game parameters are variables which can take on a variety of values, and that may be adjusted during game play. Parameters may be stored, for example, in the parameter value database 322 of the gaming device 104. These parameters can serve to control one or more elements of slot machine play, such as those described below.

Such parameters are especially useful for slot machine games that span a number of spins and in which multiple activities are happening both in a basic game (e.g., the spinning reels) and in secondary game elements (e.g., a secondary game screen where the player is accumulating puzzle pieces). In some respects, the parameters determined may represent states of the gaming device 104.

Some types of multi-spin games encompass a fixed number of handle pulls, or a fixed amount of game play time, for a flat rate price. Other types, however, may not be defined by a fixed number of handle pulls or by a fixed amount of game play time. For example, as explained further below, some types of multi-spin games may be defined based on a number of game elements (e.g., a number of “carrots” growing in a virtual garden) that a player has remaining. Once the stock of the game elements is exhausted, the game session ends. A player may or may not have to prepay for a multi-spin game session.

Examples of parameters include: a number of game symbols to start a session with (e.g., a number of carrots that a player is awarded as an initial starting value in a game spanning a number of spins); a maximum number of spins allowed before a player is ineligible for a puzzle completion bonus; a number of game elements or symbols “collected” by a player (e.g., reel symbols, card values); a rate of expiration of collected symbols (e.g., a player might be paid ten coins for each cherry symbol accumulated over a twenty-five spin game, but the cherries gradually lose value after every handle pull—the expiration rate could be expressed as the number of credits in lost value per handle pull); a probability of a player getting into a bonus round (e.g., this might initially have a fairly small value and then increase gradually with every spin until the probability eventually reaches 100%, at which time the game session concludes and the player enters the bonus round); a number of game elements that need to be collected by a player during a game (e.g., a number of puzzle pieces appearing on the reels of a puzzle-themed slot machine game); a number of video poker hands played during a session; a number of whammy symbols which may reduce a player's credit balance; a number of handle pulls and/or an amount of time that a prepaid session and/or bonus game will last; and/or the like.

Some types of game parameters may be counts of particular game elements or events. For example, the “carrot” parameter represented in FIG. 6 may correspond to a running count of how many carrot symbols the player has left in an exemplary “Garden Game” discussed further below. In another example, a game parameter value may indicate how many cherry reel symbols a player has received during a game session.

Of course, other types of counts may be used in accordance with different types of games, as deemed practicable for a particular application. In some embodiments, terminating values may be associated with particular game stages, in addition to or in lieu being associated with an entire game session. For example, a “Treasure Hunt Game” may involve a player “finding treasure” in a first game stage. Whenever a “treasure chest” symbol appears on a slot machine payline, the player collects that chest (e.g., the found chest may be represented on a secondary game screen). After the player has found three treasure chests (e.g., over any number of reel spins), the game enters a new mode where the player may be able to “open” one or more of the chests he found (e.g., based on a random outcome) and receive a corresponding payout. Accordingly, one parameter of the Treasure Hunt Game may correspond to a running count of how many chests the player has found so far, and the terminating value for this example would be “3” (i.e., once three chests are found, the first stage terminates and the second “payout” stage begins). Some other examples of parameters associated with running counts include a number of Aces received by a player in video poker, and a number of losing handle pulls achieved by a player.

Other types of counts will be readily apparent to those having skill in the art in light of the present disclosure. Methods and apparatus that, among other things, permit and enable various ways of determining and tracking running counts related to games and game events, and are appropriate for use in accordance with the present invention, are disclosed in U.S. patent application Ser. No. 10/778,576, filed Feb. 13, 2004, entitled “METHOD AND APPARATUS FOR ENHANCED PLAY OF A GAMING DEVICE,” the entirety of which is incorporated herein by reference.

As an illustration of some embodiments of the present invention, the following “Garden Game” example will be referred to throughout the following example process steps. In the Garden Game (a three-reel slot machine game), the player pays twenty credits for a single game that spans multiple handle pulls. The player's garden is populated with a number of carrots, and the game includes a rabbit character that hops onto the screen occasionally to eat the carrots. The player can win coins on each spin, and the game continues until the rabbit has eaten all of the carrots.

Two other game elements are included: a fox character and fence symbols. The fox can scare away the rabbit, and the fence symbols can be used to erect a full or partial fence around the garden, reducing the chance that the rabbit is able to steal one or more carrots.

A secondary screen shows a graphical image of the garden, carrots, and other game elements. Animated images of the rabbit and fox characters are periodically displayed on the secondary screen. These game characters are activated when a reel symbol of the basic game occurs on a payline. For example, the first reel may have three rabbit symbols. When one of these appears on the payline, the gaming device animates the rabbit character on the secondary screen and has it steal one or more carrots. Fox symbols and fence symbols also appear on the reels and trigger their respective game elements to appear on the secondary screen. There are many possible parameters in this game, but for brevity, only the parameter related to a number of carrots the player has remaining will be considered in further detail.

Other possible parameters related to the Garden Game could include, for example, the number of carrots that the rabbit steals on each attempt, the probability that the rabbit is successful in a steal attempt, the number of spins during which the fox is able to scare away the rabbit, the extent of coverage provided by each fence symbol, the probability of the rabbit knocking down a fence, the number of poisoned carrots (which could kill a rabbit), the coin value for achieving an outcome of fox-fox-fox on the payline, etc.

It will thus be understood that more than one game parameter may be determined during step 702. For example, a first parameter may indicate a number of carrots remaining, and a second parameter may correspond to the set of reel symbols associated with a generated outcome. As discussed further below, the first parameter may be associated with one or more respective terminating conditions, and the second parameter also may be associated with one or more respective terminating conditions. For instance, the game session may end if either (i) the number of carrots falls to zero or (ii) an outcome of “fox-fox-fox” or “fence-fence-fence” is generated. Thus, terminating a game session may be based on any number of game parameters, each game parameter having any number of associated terminating values.

In step 704, a respective terminating condition is determined for any of the determined game parameters.

Determining a terminating condition preferably includes determining a terminating value associated with a determined game parameter. Game parameters, and the values of game parameters (including the possible values or initial values of a game parameter) may be determined in a variety of ways, such as by selection of a player or casino, or at random.

In one example of determining a terminating value, the slot machine may refer to parameter value database 322 to identify a terminating value 608 of a game parameter. For instance, the tabular representation of the parameter value database 322 indicates that the “carrots” parameter has an associated terminating value of “0.” Accordingly, if the value of that parameter falls to zero (i.e., if rabbits steal all of the player's carrots), the player's game session will end.

In some embodiments, the slot machine may determine the terminating value for a parameter based on a set of possible terminating values. For example, the tabular representation of the parameter value database 322 indicates that the “aces” parameter has three possible parameter values 602 (“1,” “2,” “3”). In this instance, the three parameter values 602 are possible terminating values. According to the exemplary data, a player's prepaid session of video poker might end after being dealt one ace, after two aces, or after three aces. Determining the terminating value for the game session may include, for example, determining at random which possible terminating value will be used for play of a game session (e.g., based on the associated probabilities 604), or allowing the player to select a terminating value from the set of allowable values.

In the example of the Garden Game introduced above, the terminating value for the number of carrots would be zero, indicating that when the player runs out of carrots the game is over. In a video poker example, a prepaid video poker session encompassing multiple plays will terminate if the player has a hand that is a Jack-high straight. Accordingly, the terminating value would be “Jack-high straight,” where the associated parameter corresponds to a hand outcome achieved by the player (e.g., based on cards dealt to a player).

Various other types of terminating values will be readily understood in light of the present disclosure related to game parameters. Some other examples of types of terminating values include, without limitation:

(i) Time (e.g., a game session ends when a clock has reached noon)

(ii) Number of winning outcomes (e.g., the game ends when the player achieves his third payout of twenty coins or more)

(iii) Number of losing outcomes

(iv) Number of flushes completed in video poker (e.g., end the game session when the player successfully completes three one-card flush draws)

(v) A particular card value (e.g., end the game session when the player is dealt an Ace of spades, or when the player is dealt any club)

(vi) Particular hand outcome (e.g., blackjack, flush, Jack high straight, four Aces)

(vii) Number of bonus rounds achieved

(viii) Number of game symbols accumulated

(ix) Another player achieving a particular hand outcome (e.g., a royal flush)

Methods and apparatus which, among other things, permit and enable various ways of determining game parameters, determining possible (initial and/or terminating) values of game parameters, and setting values for game parameters, and are appropriate for use in accordance with the present invention, are disclosed in U.S. patent application Ser. No. 10/XXXXXX [Attorney Docket Number 03-011], filed Feb. 23, 2004, entitled “METHOD AND APPARATUS FOR SETTING GAME PARAMETERS,” the entirety of which is incorporated herein by reference. For example, that application discusses various ways of setting an initial value of a parameter (e.g., what parameter value play will begin with) that likewise may be used for establishing the terminating value of a parameter (e.g., what parameter value will end play), such as by using a slot machine reel spin to determine a parameter value at random.

In some embodiments, there is only one terminating value established for a parameter. In other embodiments, there may be more than one determined terminating value (e.g., a range or set of terminating values). For example, a slot machine session may end if the payline indicates exactly one cherry symbol or exactly three cherry symbols, but will not end if exactly two cherry symbols appear. Thus, both “1” and “3” may be terminating values for a corresponding parameter that tracks the number of cherry symbols appearing with each outcome.

Some embodiments may use a terminating value that is a threshold value. For example, a terminating value may be a minimum value. If the game parameter value falls to (or below) the terminating value, the game session will end. Likewise, a terminating value may be a maximum value, which if met (or exceeded) will result in termination of play.

According to some additional embodiments, determining a terminating condition may comprise determining one or more rules for determining when play should end. For example, a terminating condition could include a rule that if the player attempts to retrieve his player tracking card, the game session will end. In another example, a terminating condition could include a rule that a game session will end if the player walks away from the machine (e.g., as indicated by a motion sensor or lack of player interaction for a period of time). In another example, a terminating condition could include a rule that a game session will terminate based on an appropriate signal from casino personnel or from a slot server.

According to some embodiments, determining a terminating condition may include a condition related to an external event. The occurrence of an external event is not directly influenced by the player, the gaming device, or play of the game. For example, a terminating condition may be associated with an outcome or event in a sports game (e.g., a home run by a professional baseball player, a win by a local high school football team). In another example, a termination condition may be associated with a weather event (e.g., the temperature reaching a certain value). Thus, according to some embodiments, a game session may be terminated upon the occurrence of an external event.

Once a terminating condition or value is determined, it may be stored, for example, in the parameter value database 322, for use in determining when a game session should end.

In step 706 it is determined whether the terminating condition has occurred. In some embodiments this will include determining whether a terminating value for a game parameter has been reached. In some embodiments, this will include determining a current value of a game parameter (e.g., the number of carrots a player still has) and determining whether the current value is equal to the terminating value.

For instance, referring to the example of the Garden Game and to the exemplary representation of the parameter value database in FIG. 6, the slot machine retrieves the current value of the number of carrots remaining (e.g., the current value 606) and checks to see whether or not it has reached zero (i.e., the terminating value 608).

In some embodiments, determining whether a terminating value has been attained may include determining a change to a game parameter value (e.g., a change to the current value of a game parameter). In some embodiments, determining whether a terminating value has been attained may include determining an outcome (e.g., the result of a handle pull, a hand of cards dealt in video poker). The outcome determined may directly affect whether the terminating value has been reached, or it may indirectly affect whether the terminating value has been reached. For example, an outcome of“cherry-bell-cherry” would directly affect whether the terminating value had been reached, if the terminating value was “20” for a parameter corresponding to the collection of cherry symbols.

In another example, a “fence-fence-rabbit” outcome in the Garden Game may not have a direct impact on the number of carrots remaining in that it may not necessarily affect the running count of how many carrots remain. The appearance of a rabbit as a result of the “rabbit” symbol, could result in one or more carrots being stolen. Such an outcome therefore may have an indirect influence on whether or not a terminating value has been reached.

In addition to or in lieu of a game parameter value changing based on an outcome, the process of changing one or more game parameters could be triggered by actions of the player. Such actions might include, without limitation:

(i) Player loses more than X spins in a row

(ii) Player gets X “close calls” in a row (e.g., two of the reel symbols match)

(iii) Player loses more than $X in Y minutes/handle pulls

(iv) Player deposits more than $X into the machine

(v) Player speeds up play

(vi) Player slows down play

Determining a change to a parameter value (e.g., determining the current value of a game parameter) may take place at various times. Examples of when parameter values could be established or adjusted include, without limitation:

(i) Before every spin

(ii) At the beginning of each game

(iii) Upon request by the player

(iv) Upon the occurrence of a random triggering event

(v) At a predetermined time (e.g., every one hundred spins)

(vi) When a particular payout occurs

(vii) When the player inserts his player tracking card

(viii) When the player inserts a bill into the bill validator

(ix) When the credit balance of the player reaches a predetermined level

In step 708, if the terminating condition has occurred, play of a game session is terminated. For example, the slot machine will end a session of the Garden Game once the player has run out of carrots (i.e., the terminating value of zero has been reached). In some embodiments, terminating the game means ending that particular game session and preventing the player from continuing with any free spins.

According to some embodiments, once a game session is terminated the player may be allowed to pay for another game session and/or may be offered another prepaid session.

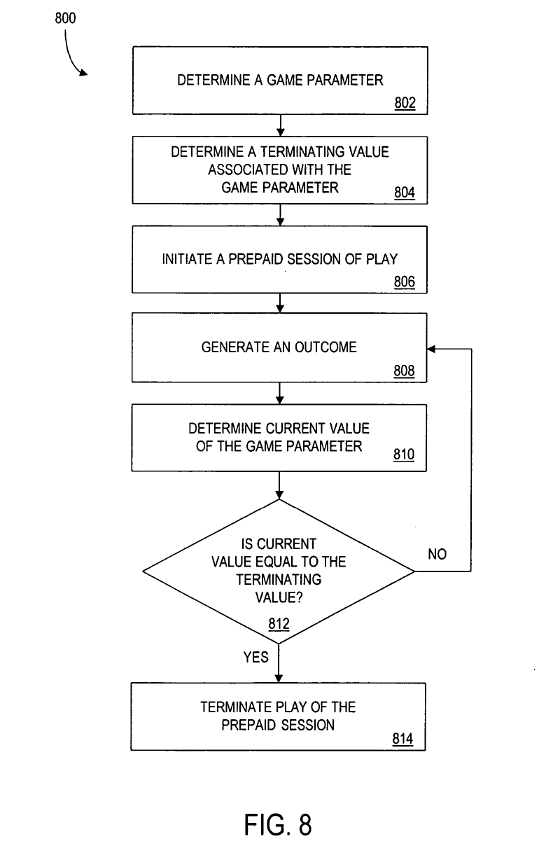

Referring now to FIG. 8, a flowchart illustrates a process 800 that is consistent with one or more embodiments of the present invention. The process 800 is a method for terminating a prepaid session based on a terminating value. For illustrative purposes only, the process 800 is described as being performed by a slot machine. Of course, the process 800 may be performed by a controller 102, a gaming device 104, a peripheral device 210, a peripheral device server 216, and/or a casino or casino personnel.

In step 802, the slot machine determines a game parameter. Various types of game parameters and ways of determining such are discussed herein. For example, the slot machine may refer to parameter value database 322 to identify a “carrots” parameter that is used to store and track a number of carrot game elements a player currently has remaining in a prepaid session of the exemplary Garden Game.

In step 804, the slot machine determines a terminating value associated with the game parameter, as discussed variously herein. For example, the terminating value for remaining carrots in the Garden Game is zero. An indication of the terminating value may be stored in and/or retrieved from the parameter value database 322.

In step 806, the slot machine initiates a prepaid session of play. Initiating a prepaid session may include determining and/or receiving a payment for the prepaid session. The cost of some types of prepaid sessions may be predetermined. For instance, any play of the exemplary Garden Game might cost twenty credits. Some types of prepaid sessions may allow for a player to select parameters that define the session (e.g., number of handle pulls, number of a particular reel symbol), and the price for the session may be determined based on such parameters. Methods and apparatus that, among other things, permit and enable various ways of determining the price of a game session, and are appropriate for use in accordance with the present invention, are disclosed in U.S. patent application Ser. No. 10/001,089, filed Nov. 2, 2001, entitled “GAMING DEVICE FOR A FLAT RATE PLAY SESSION AND METHOD OF OPERATING SAME,” which is incorporated by reference herein.

In some embodiments, initiating play may include receiving a signal from the player. For example, after making a required prepayment, the player may press a “Start Game” button or “Spin” button of the slot machine to begin the game session. In other examples, the player may indicate a wager amount, select a number of paylines to activate, or select the initial value for a game parameter (e.g., a starting number of carrots in the Garden Game).

In some embodiments, during the game session the player may make a number of handle pulls until play is terminated (e.g., by initiating each handle pull). Initiating the prepaid session may include activating a “Spin” button, enabling an input device so that the player can initiate handle pulls, or otherwise configuring the slot machine to generate an outcome in response to receiving a signal from the player.

In other embodiments, the player need not initiate individual handle pulls. For example, the slot machine may generate a series of outcomes automatically in a game session, without requiring any player interaction. Other various ways of initiating play at a gaming device will be readily understood by those having ordinary skill in the art.

In step 808, the slot machine generates an outcome for the game session. In some embodiments, a random number is generated by the random number generator of the slot machine, and this random number is then associated with an outcome in the probability database, in a manner well known in the art. For example, the random number 03459 might correspond to the result of“fence-fence-rabbit.” As discussed herein, those of ordinary skill in the art will appreciate that there are many methods by which to determine a random number or outcome, such as algorithms stored in electronic memory or physical random number generators (such as a lottery blower type device).

In step 810, the current value of the game parameter is determined. Various examples of game parameters are described herein and with respect to FIG. 7. In the exemplary Garden Game, determining the current value of the carrots remaining parameter may include looking up the current value 606 in the parameter value database 322. In some embodiments, as discussed herein, determining the game parameter value may include adjusting the value based on the outcome generated in step 808. For example, the current value of a running count of cherry symbols may be increased by one if the outcome of a handle pull includes one cherry symbol.

In step 812, the slot machine determines if the current value of the game parameter is equal to the terminating value. In the case of the Garden Game, this may include determining if the current number of carrots remaining is zero. Of course, as discussed herein, some types of terminating values need not be exactly equaled in order to terminate play, but may be, for example, a maximum or minimum threshold value.

If the current value equals the terminating value, then play of the prepaid session is terminated in step 814. Otherwise, the process returns to step 808 to generate another outcome.

In some embodiments, in which the session is not associated with a fixed period of time or with a fixed number of handle pulls, a player may continue making any number of handle pulls for an indefinite period of time, in exchange for a single prepayment. Thus, some embodiments of the present invention allow for a game session of variable or indefinite duration.

The following examples illustrate some additional embodiments and features of the present invention. The following examples are provided merely to illustrate some embodiments of the present invention, and should not be construed as limiting the scope of the invention in any way. Various other embodiments and examples of embodiments are discussed in further detail herein, and others will be apparent to those skilled in the art in light of the present disclosure.

According to one example of a game session in accordance with at least one embodiment of the present invention, a player inserts a bill into the bill validator of a Garden Game slot machine and establishes a balance of eighty credits. The player is allowed to begin with ten carrots, which populate a virtual garden on a secondary screen. These carrots are periodically stolen by a rabbit game character, with the rabbit stealing one carrot every time a rabbit symbol appears on the payline of one of the reels. The game costs twenty credits, and the player spins until all of his initial ten carrots are stolen (e.g., until a total of ten rabbit symbols have appeared).

According to another example, a player chooses to play a slot machine game with a cooking theme, called “Bake the Cake.” In this exemplary game, the player selects a recipe and then tries to collect all of the necessary ingredients in as short a time as possible. For example, the player might choose chocolate chip cookies as his recipe and have to collect all of the following ingredients: flour, oats, salt, water, baking soda, eggs, sugar, butter, and chocolate chips. Each of these ingredients appears as a game symbol on one or more of the reels of the slot machine. The player spins the reels. Whenever ingredients of the player's recipe appear on the payline, they go into a cooking bowl displayed on the secondary screen of the slot machine. When all of the ingredients have been accumulated, the basic game ends. The player is then provided a coin payout based on the number of spins that it took him to collect all of the ingredients. In this game the parameter associated with the terminating value is indicative of the ingredients collected so far, and the terminating value is the full set of required ingredients (i.e., once all of the required ingredients are collected, the handle pull/collection stage ends).

In yet another example, a player pays twenty credits for a slot machine game in which the object is to win an election for the presidency of the United States. The player plays against a computer-generated opponent, and each spin of the game reveals a state. For example, an outcome might be “Texas-Texas-Texas.” A second random determination is made to see which of the three Texas symbols is “won” by the player. If the player wins a majority of the Texas Symbols (i.e. winning 2 or 3 of the symbols) then he collects all of the corresponding electoral votes for that state. The game continues (i.e. the player may continue making spins), until either the player or his computer opponent collects two hundred seventy electoral votes. That player is declared the winner. The player receives a payout based on the total number of electoral votes he won. If the player wins the election by a large margin, additional payouts are earned. In this exemplary game, “270” is a terminating value for the respective game parameters used to track the number of votes collected by each of the players.

In yet another example, a “Getaway Racing” game allows a player to continuing making handle pulls so long as he has at least one tire remaining on his car. The player starts the game with four tires, and he loses a tire each time a “spike” symbol appears on the payline. When he runs out of tires, the game session ends.

In another example, a “Fruit Collection” game allows a player to continue a game session until all of his collected fruit has rotted. The player accumulates fruit based on fruit symbols appearing on the payline of the slot machine. The fruit, however, expires over time (e.g., in increments), at random, and/or based on a generated outcome (e.g., including a “rot” game symbol). If a “jar” symbol appears on the payline, one or more of the collected fruits may be “preserved” from rotting, e.g., for a period of time, for a number of spins, etc.

5. Additional Embodiments

Some additional embodiments of the present invention allow for a game session including play of a video poker game. For example, the game session may include a plurality of hand outcomes based on cards dealt to a player (e.g., in one or more rounds of dealing). As discussed herein, the game session may be a flat rate play session or a prepaid session. Examples of terminating values that may be useful in video poker include, without limitation, a rank of a card (e.g., “9,” Ace), a card suit (e.g., Hearts), a particular card (e.g., Jack of hearts), a particular hand outcome (e.g., a flush, three of a kind).

According to one alternative embodiment, a player could be offered the opportunity to exchange one or more payouts for a change to a current game parameter value. For instance, in the exemplary Garden Game, whenever the player wins a payout of five coins, the gaming device could offer to add three more carrots to the player's garden in exchange for the five coins. In this way, a player may be able to prolong play.

In another embodiment, the gaming device includes a button on the console labeled “Buy more carrots.” When the player presses the button the gaming device asks the player how many carrots he wants to buy, and provides prices for each number.

According to one or more alternative embodiments, instead of the gaming device terminating the game session when one or more parameter values reaches a predetermined value, the gaming device could change the state of the gaming device. For example, as discussed above in reference to the exemplary Treasure Hunt Game,'a terminating value could cause a gaming device to terminate a first stage of a game and begin a new stage, such as a bonus round or payout mode.

As discussed herein, play of a game session may encompass play of multiple gaming devices. A game session may also include play during different periods of time. For example, a player may wish to stop a game session prematurely (e.g., before a terminating value has occurred). According to some embodiments, the player may then restart the game session where he left off, at another gaming device and/or the next day (or any other time). Some types of players may find this flexibility in how a game session may be played appealing. In some embodiments, when the player pauses or quits (temporarily) the game session, one or more parameter values corresponding to the game session may be stored in association with a player identifier (e.g., in a player database or session database stored at a casino server). When the player subsequently inserts his player tracking card at a gaming device (or otherwise identifies himself), the gaming device may ask the player if he would like to continue playing the game session where he left off. The corresponding parameter values may then be retrieved from storage if the player wishes to continue. In some embodiments, information about a game session may be stored on a player tracking card. In some other embodiments, a player quitting a game session prematurely may receive a cashless gaming receipt from the gaming device. The receipt may be inserted in another gaming device in order to resume the gaming session. For example, the receipt may include a player identifier, indications of various parameter values, and/or a session identifier for use in determining (e.g., by reference to data stored in a database) how to resume the game session (i.e., how to recreate the conditions existing when the session was ended). Thus, various embodiments of the present invention provide for the portability of a game session from one machine to another and/or the flexibility to pause and resume play of a game session at different times, as desired.

As discussed herein, in some embodiments a controller may determine that a terminating condition has been satisfied and signal to a gaming device that a game session should be terminated. According to some additional embodiments of the present invention, a controller may determine that a plurality of game sessions should be terminated based on the occurrence of some event or satisfaction of a terminating condition. For instance, a casino slot server may determine a terminating value for a bank of video poker machines, such as the achieving of a royal flush by any player. A group of players may be allowed to play the video poker machines repeatedly (e.g., without making a per-spin wager), until a royal flush. is generated at any one of the machines. The server monitors play at all of the participating machines (e.g., based on game information received from the individual machines). When the royal flush occurs, all game sessions are terminated by the server, for example, by sending a signal to each participating machine. In some embodiments, a number of game sessions may be terminated at substantially the same time. The termination of a group of game sessions (and the anticipation of such an event) may be an exciting game experience for the group of participating players.

While the method and apparatus of the present invention have been described in terms of its presently preferred and alternate embodiments, those skilled in the art will recognize that the present invention may be practiced with modification and alteration. The specifications and drawings are, accordingly, to be regarded in an illustrative rather than a restrictive sense. Further, even though only certain embodiments have been described in detail, those having ordinary skill in the art will certainly appreciate and understand that many modifications, changes, and enhancements are possible within the scope of the accompanying claims. All such modifications are intended to be encompassed within the following claims.

What is claimed is:

1. A method comprising:
initiating a game session of indeterminate duration;
determining a game variable defining the game session;
determining a terminating value associated with the game variable;
determining a current value of the game variable; and
terminating the game session based on the terminating value and the current value.

2. The method of claim 1, in which determining the current value comprises:
determining the current value based on an outcome of the game session.

3. The method of claim 1, in which the game session is not defined by a predetermined number of handle pulls.

4. The method of claim 1, in which the game session is not defined by a predetermined period of time.

5. The method of claim 1, in which the game session is not defined by a predetermined number of winning outcomes.

6. The method of claim 1, in which the game session includes a plurality of plays of a game.

7. A method comprising:
determining at least one game parameter that is associated with a game;
for each at least one game parameter, determining a respective terminating condition that is associated with the game parameter;
initiating a flat rate play session of the game;
determining if at least one terminating conditions is satisfied; and
if at least one terminating conditions is satisfied,
terminating the flat rate play session,
in which the at least one game parameter corresponds to at least one of:
a number of game elements,
a number of occurrences of a game symbol, and
a plurality of game elements collected by a player.

8. The method of claim 7, further comprising:
determining an outcome of the game.

9. The method of claim 8, in which determining if the terminating condition is satisfied comprises:
determining if the terminating condition is satisfied based on the outcome.

10. A method comprising:
determining at least one game parameter that is associated with a game;
for each at least one game parameter, determining a respective terminating condition that is associated with the game parameter;
initiating a flat rate play session of the game;
determining if at least one terminating conditions is satisfied; and
if at least one terminating conditions is satisfied,
terminating the flat rate play session,
in which the at least one game parameter corresponds to at least one of:
a probability,
a probability of a player entering a bonus round, and
a rate of expiration of a predetermined game symbol.

11. A method comprising:
initiating a game session, the game session including a plurality of handle pulls;
determining a game parameter that is associated with a first stage of the game session;
determining a terminating value that is associated with the game parameter;
determining an outcome of the first stage;
determining a current value of the game parameter; and
initiating a second stage of the game session based on the terminating value and the current value.

12. The method of claim 11, in which the first stage comprises a primary game.

13. The method of claim 11, in which the second stage comprises a bonus round.

14. The method of claim 11, in which determining the current value comprises:
determining the current value based on the outcome.

15. The method of claim 11, in which the game session is a prepaid session.

16. The method of claim 11, further comprising:
terminating the first stage based on the terminating value and the current value.

17. A method comprising:
initiating a game session that includes a plurality of outcomes;
generating at least one outcome, in which
each outcome includes a plurality of instances selected from a set of slot machine symbols, and
the set of slot machine symbols includes a plurality of predetermined slot machine symbols;
adjusting a running count based on occurrences of the at least one predetermined slot machine symbol in the at least one outcome; and
terminating the game session based on the running count.

18. The method of claim 17, further comprising:
determining a bonus payout based on the running count.

19. A method comprising:
determining a game parameter value that is associated with a video poker game;
determining a terminating value that is associated with the game parameter value;
initiating a session of the video poker game, the session including a plurality of hand outcomes;
determining if the game parameter value is equal to the terminating value; and
if the game parameter value is equal to the terminating value, terminating the session.

20. The method of claim 19, in which the session is a flat rate play session of the video poker game.

21. The method of claim 19, in which the terminating value corresponds to a rank of a card.

22. The method of claim 19, in which the terminating value corresponds to a suit of a card.

23. The method of claim 19, in which the terminating value corresponds to at least one card.

24. The method of claim 19, in which the terminating value corresponds to a predetermined hand outcome.
